(19) United States
(12) Patent Application Publication
(10) Pub. No.: US 2005/0010752 A1
(43) Pub. Date: Jan. 13, 2005

(54) Method and system for operating system anti-tampering

(75) Inventors: Marc Solsona, Mountain View, CA (US); Ajay Mittal, Foster City, CA (US)

Correspondence Address: MERCHANT & GOULD PC, P.O. BOX 2903, MINNEAPOLIS, MN, 55402-0903, US

(73) Assignee: Nokia, Inc., Irving, TX (US)

(21) Appl. No.: 10/602,196

(22) Filed: Jun. 23, 2003

(51) Int. Cl. H04L 9/00

(52) U.S. Cl. 713/151

(57) ABSTRACT

A system and method is directed to detecting tampering of a computer system's operating system (OS). The OS includes a kernel binary and at least one user level binary. When the user level binary is generated, selected integrity data is also generated. Such integrity data may include, but is not limited to, a digital signature, a hash associated with the user level binary, and the like. In one embodiment, integrity data is also generated for the kernel. The kernel is modified to include the integrity data associated with the user level binary. The kernel further includes a tamper detector that is configured to examine the OS binary against its associated integrity data. If tampering is detected, the tamper detector may provide a message indicating which OS binary may have been modified. The tamper detector may also quarantine the modified OS binary, log the message, and the like.

### FIELD OF THE INVENTION

The present invention relates generally to data security, and in particular to a method and system for determining tampering of an operating system binary.

### BACKGROUND OF THE INVENTION

Virtually every general-purpose computer system today includes an operating system (OS). Operating systems perform many tasks, such as recognizing input from a keyboard, sending output to a display screen, keeping track of files and directories on a storage medium, and controlling peripheral devices such as disk drives and printers, and the like. Operating systems may also provide a software platform on which other programs, sometimes called user application programs may execute.

Typically, a computer's operating system includes many-binary level programs to perform such tasks. Generally, the binary level programs may be categorized into two major categories: a kernel, and an operating system (OS) user level binary. The kernel includes a central program of an operating system. The kernel is that part of the operating system that generally loads first and remains in a computer system's main memory. The OS user level binary may include a program operating as a device driver, graphical user interface, and the like. One or more vendors, other than the vendor that develops the kernel, may often develop the OS user level binaries.

In recent years the OS user level binaries, however, have seen many virus and Trojan attacks. In these attacks a malicious user, software program, or the like, may modify an OS user level binary to gain illegal access to a computer, or inflict damage to the computer system itself Currently, many administrators of these computer systems do not have the necessary mechanisms in place to detect an OS user level binary tampering by a malicious user. Thus, there is a need in the industry to provide a mechanism for detecting tampering of at least OS user level binaries. Therefore, it is with respect to these considerations, and others, that the present invention has been made.

### SUMMARY OF THE INVENTION

The present invention is directed to addressing the above-mentioned shortcomings, disadvantages and problems, and will be understood by reading and studying the following specification. The present invention provides a system and method directed to protecting a computer system's operating system (OS).

In one aspect of the invention, a method is directed to protecting an operating system. Integrity data associated with an operating system binary is determined. The integrity data enables detection of a modification to the operating system binary. A kernel is modified with the integrity data. The kernel is operable to employ the integrity data to detect the modification to the operating system binary.

In another aspect of the invention, a method is directed to protecting an operating system. The method generates a first integrity data associated with an operating system binary. The method also modifies an operating system kernel with the first integrity data. The method includes receiving a request associated with the operating system binary, and retrieving the first integrity data associated with the operating system binary. The method determines that the first integrity data indicates tampering of the operating system binary, a tamper detection action is performed.

In still another aspect of the invention, a method is directed to protecting an operating system by receiving a request associated with an operating system binary, retrieving integrity data associated with the operating system binary, and performing a tamper detection action, if the integrity data indicates tampering of the operating system binary.

In yet another aspect of the invention, a computer-readable medium having computer-executable components is directed to protecting an operating system. The computer-executable components include a data store and a tamper detection component. The data store is configured to receive and store a first integrity data. The first integrity data is associated with an operating system binary. The tamper detection component receives a request to examine an operating system binary. The tamper detection retrieves the first integrity data associated with the operating system binary. If the first integrity data indicates tampering of the operating system binary, the tamper detection component performs a tamper detection action.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates an exemplary environment in which an Operating System (OS) tamper detector may operate;

FIG. 2 illustrates one embodiment of an OS tamper detector within a protected OS environment;

FIG. 3 illustrates components of an exemplary computer system environment in which the invention may be practiced;

FIG. 4 illustrates a flow chart for one embodiment of a process for creating an OS binary image that includes integrity data associated with a protected OS binary; and

FIG. 5 illustrates a flow chart for one embodiment of a process for detecting tampering of a protected OS binary of FIG. 4, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The term “coupled,” and “connected,” include a direct connection between the things that are connected, or an indirect connection through one or more either passive or active intermediary devices or components.

The terms “comprising, “including,” “containing,” “having,” and “characterized by,” include an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

Briefly stated, the present invention is directed towards a system and method for protecting of a computer system's operating system (OS). The OS may include a kernel binary and an OS user level binary. When the OS user level binary is generated, selected integrity data is also generated. Such integrity data may include but is not limited to, a digital signature, a hash associated with the user level binary, and the like. The hash may include a Message Digest (MD), such as MD-4, MD-5, a Secure Hash Algorithm (SHA), and the like. In one embodiment, integrity data is generated for the kernel. In another embodiment, the integrity data is included in a tamper store, such as a database, file, a program, and the like. The kernel is modified to include the integrity data associated with the user level binary and the kernel, such that the integrity data and the OS user level binary are strongly associated with a particular operating system build. The kernel further includes a tamper detection component that is configured to examine the OS binary against its associated integrity data. If tampering is detected, the tamper detection component may provide a tamper detection message indicating which OS binary may have been modified. The tamper detector may also quarantine the modified OS binary, log the tamper detection message, and the like.

Illustrative Operating Environment

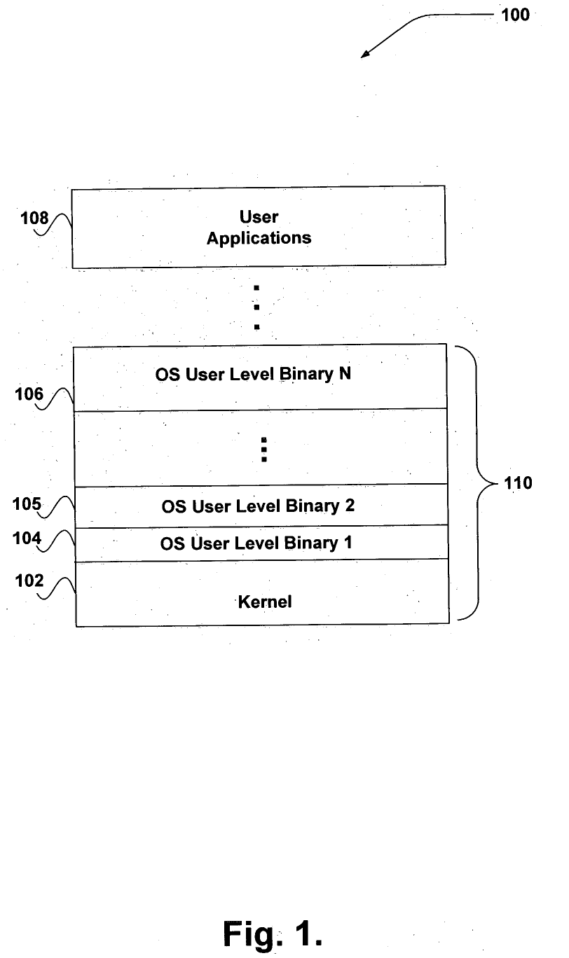

FIG. 1 illustrates an exemplary environment in which an OS tamper detector may operate. Not all of the components may be required to practice the invention, and variations in the arrangement and type of the components may be made without departing from the spirit or scope of the invention.

As shown in the figure, system 100 includes OS 110 and user applications 108. OS 110 includes kernel 102 and OS user level binaries 104-106. OS 110 is in communication with user applications 108. Kernel 102 is in communication with OS user level binaries 104-106. Typically, OS 110 operates within a process space known sometimes as kernel mode. Kernel mode includes a mode of execution in a computer processor that may grant extensive access to system memory, and CPU instructions at a higher privilege level than user applications 108 might typically receive.

Kernel 102 includes OS 110 binaries that typically reside in a computer system's memory to provide basic computer system services. As such kernel 102 is generally loaded into memory first. Kernel 102 may be configured to provide such actions, including, but not limited to, thread scheduling, interrupt and exception dispatching, multiprocessor synchronization, memory management, security, interprocess communication, disk management, and the like.

OS user level binaries 104-106 include OS 110 binaries typically operable to provide additional OS level services. Such services may include, but are not limited to, providing hardware device drivers, hardware abstraction layers, and windowing, graphical interfaces, user interfaces, menus, and the like. Hardware device drivers may include those binaries configured to translate user input/output (I/O) calls into specific hardware device I/O requests. Hardware device drivers may also include file system and network drivers. A hardware abstraction layer binary may be configured to isolate kernel 102, device drivers, and the like, from platform-specific hardware differences, such as differences between a computer system's motherboard. Windowing, graphical interfaces, menus, and user interfaces typically include functions, methods, and the like, that provide a visual interface between an end-user and the computer system. OS user level binaries 104-106 may be developed, and provided, by a vendor other than the vendor that may supply kernel 102. During the development and delivery of OS user level binaries 104-106, they may be susceptible to a malicious attack. Moreover, even when OS user level binaries 104-106 are installed in a computer system they may open to an attack.

User applications 108 include, but are not limited to, binaries associated with data entry, query, report generators, word processors, editors, spreadsheet programs, database programs, tool development programs, security tools, file management tools, file transfer programs, email programs, graphic presentation tools, drawing tools, browsers, and the like. User applications 108 typically operate in a protected process address space, known as a user mode, although while they are executing they may do so in kernel mode.

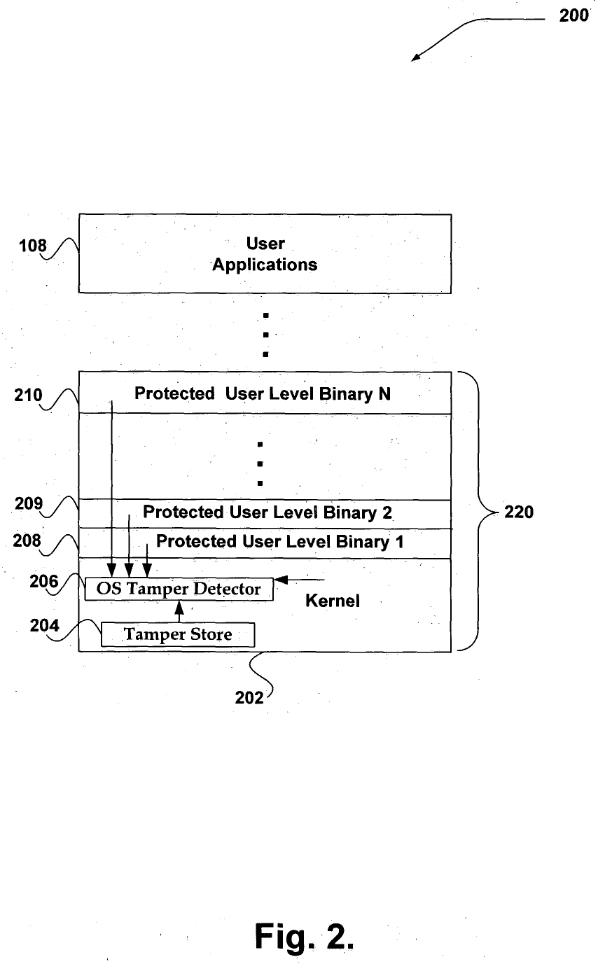

FIG. 2 illustrates one embodiment of an OS tamper detector within a protected OS environment. Components numbered similarly to those in FIG. 1 operate similarly. Secure system 200 may include many more components than those shown; however, those shown are sufficient to disclose an illustrative embodiment for practicing the invention.

As shown in the figure, secure system 200 includes protected operating system 220-and user applications 108. Protected operating system 220 includes protected user level binaries 208-210, and kernel 202. Kernel 202 includes OS tamper detector 206 and tamper store 204. OS tamper detector 206 is in communication with tamper store 202 and protected user level binaries 208-210.

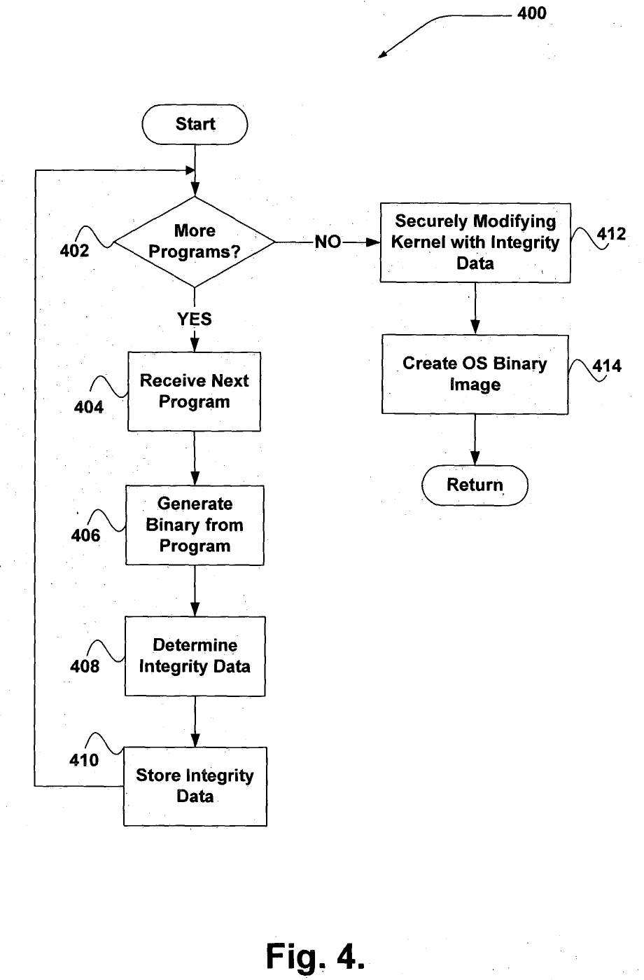

Protected user level binaries 208-210 are substantially similar to OS user level binaries 104-106 described above in conjunction with FIG. 1. Protected user level binaries 208-210 however, are generated such that integrity data associated with each protected user level binary (208-210) is available to OS tamper detector 206. Protected user level binaries 208-210 may be prepared as described below in conjunction with FIG. 4. Briefly, however, each protected user level binary 208-210 may be generated such that selected integrity data is also generated. Such integrity data may include, but is not limited to, a checksum, a hash associated with each protected user level binary 208-210, and the like. The hash may include a Message Digest (MD), such as MD-4, MD-5, a Secure Hash Algorithm (SHA), and the like. In one embodiment, the selected integrity data includes a digital signature, wherein the protected user level binary (208-210) is digitally signed. Such digital signature may be generated employing a variety of mechanisms, including a public/private key algorithm, and the like. In another embodiment, the digital signature is configured to enable detection of a modification to the protected user level binary (208-2 10) during an installation, execution, and the like.

Tamper store 202 is configured to provide storage and access to the selected integrity data for protected user level binaries 28-210. Tamper store 202 may also include integrity data associated with kernel 202. Tamper store 202 may be implemented employing a variety of mechanisms, including, but not limited to, a database, folder, file, program, and the like. In one embodiment tamper store 202 is embedded within kernel 202 to minimize access by programs other than kernel 202. In another embodiment tamper store 202 is encrypted using any of a variety of symmetric, and asymmetric key encryption algorithms. In yet another embodiment, the integrity data is digitally signed prior to placing it into tamper store 202, with an encryption key strongly associated with the kernel 202.

While tamper store 202 is illustrated as a component external to OS tamper detector 206, the present invention is not so limited. For example, tamper store 202 may be included in OS tamper detector 206, located elsewhere, and the like, without departing from the scope or spirit of the present invention.

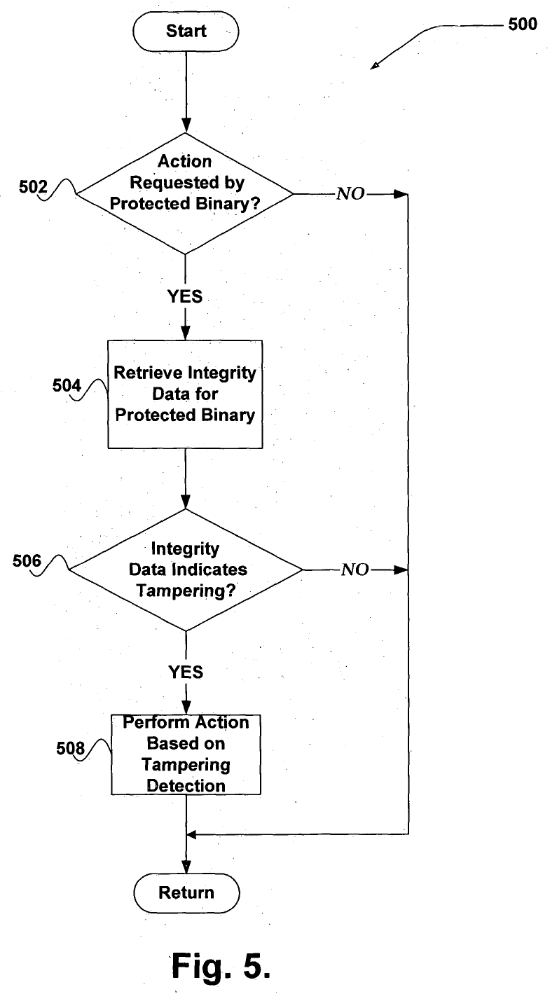

OS tamper detector 206 is operable to examine data associated with OS user level binary 208-210 and determine whether it has been modified. OS tamper detector 206 may do so by performing actions substantially as described below in conjunction with FIG. 5. Briefly, however, OS tamper detector 206, may receive the data about the integrity of OS user level binary (208-210), and compare the received data against associated integrity data stored in tamper store 202. In one embodiment, OS tamper detector 206 is configured to examine the integrity of a OS user level binary (208-210) during a read, write, and other specified operations are requested by the OS user level binary (208-2 10) upon an OS partition.

Should OS tamper detector 206 determine that the OS user level binary (208-210) might have been modified, OS tamper detector 206 is-configured to perform various actions. OS tamper detector 206 may for example, provide a tamper detection message.. The tamper detection message may be logged to provide a record of which OS user level binary (208-210) may have been modified. In one embodiment, the OS user level binary (208-210) is permitted by kernel 202 to execute, however, such execution is recorded as unsuccessful. In another embodiment, OS tamper detector 206 is configured to quarantine the modified OS user level binary (208-210). A tamper detection message may also be logged. Moreover, in another embodiment, the modified OS user level binary (208-210) is denied execution/access. However, OS tamper detector 206 is not constrained to merely notifying and quarantining, and other actions may be performed without departing from the scope and spirit of the present invention.

OS tamper detector 206 is further operable to examine kernel 202 and determine whether it has been modified.

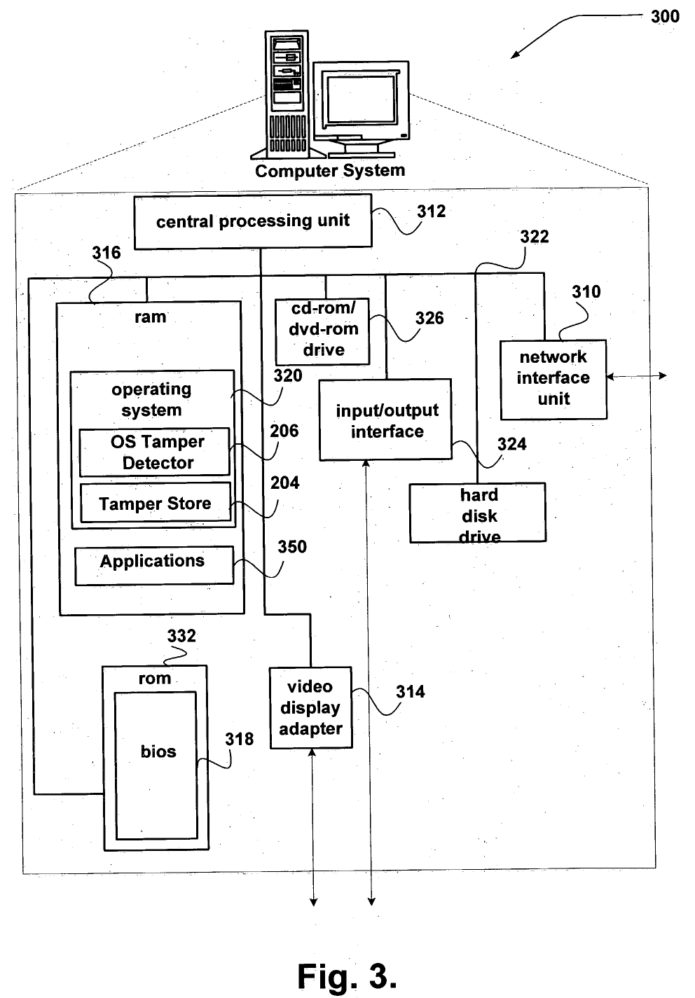

FIG. 3 shows an exemplary computer system 300 that may be included in a system implementing the invention, according to one embodiment of the invention. Computer system 300 may operate as personal computer, desktop computer, multiprocessor system, microprocessor-based or programmable consumer electronics, network PC, server, router, gateway, and the like.

Computer system 300 may include many more components than those shown. The components shown, however, are sufficient to disclose an illustrative embodiment for practicing the invention.

Computer system 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of computer system 300. Operating system 320 is substantially similar to protected OS 220 of FIG. 2. Basic input/output system (“BIOS”) 318 is also provided for controlling the low-level operation of computer system 300. As illustrated in FIG. 3, computer system 300 also can communicate with the Internet, or some other communications network via network interface unit 310, which is constructed for use with various communication protocols including the TCP/IP protocol. Network interface unit 310 is sometimes known as a transceiver or transceiving device.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, digital signatures, hashes, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

In one embodiment, the mass memory stores program code and data for performing the functions of computer system 300. One or more applications 350 are loaded into mass memory and run on operating system 320. Although not shown, operating system 320 includes a kernel and at least one protected user level binary. Operating system 320 also includes OS tamper detector 206 and tamper store 204.

Computer system 300 may also include an SMTP handler application for transmitting and receiving email for a message delivery system, an HTTP handler application for receiving and handing HTTP requests, and an HTTPS handler application for handling secure connections. The HTTPS handler application may initiate communication with an external application in a secure fashion.

Computer system 300 also includes input/output interface 324 for communicating with external devices, such as a mouse, keyboard, scanner, or other input devices not shown in FIG. 3. Likewise, computer system 300 may further include additional mass storage facilities such as CD-ROM/DVD-ROM drive 326 and hard disk drive 328. Hard disk drive 2328 is utilized by computer system 300 to store, among other things, application programs, databases, and the like.

Generalized Operation

The operation of certain aspects of the present invention will now be described with respect to FIGS. 4-5. FIG. 4 illustrates a flow chart for one embodiment of a process for creating an OS binary image that includes integrity data associated with a protected OS binary, in accordance with the present invention. In one embodiment, an OS provider may perform process 400 prior to delivery of the protected OS.

Process 400 begins, after a start block, at decision block 402, when an OS binary image for a protected operating system is to be created. At decision block 402, a determination is made whether there are more programs to be included in the OS binary image. If there are more programs, processing continues to block 404; otherwise, processing branches to block 412.

At block 404, the next program to be included in the OS binary image is received. The next program may include an OS user level program, a kernel program, and the like. Processing continues at block 406, where a binary is generated from the program. Generating a binary from the program may include compiling the program, assembling of the program, linking the program, and the like.

Processing continues at block 408, where integrity data associated with the generated binary is determined. Integrity data may include, but is not limited to, a digital signature, a hash associated with the user level binary, and the like. The hash may include a Message Digest (MD), such as MD-4, MD-5, a Secure Hash Algorithm (SHA), and the like.

Processing continues at block 410, where the determined integrity data for the protected binary is stored. In one embodiment, the determined integrity data is stored in a tamper store, such as described above in conjunction with FIG. 2. Upon completion of block 410, processing returns to decision block 402. This “loop” continues until there are no more programs to be included in the OS binary image.

When it is determined, at decision block 402, that there are no more programs to include in the OS binary image, processing branches to block 412, where the kernel is securely modified with the integrity data from block 410. This may include embedding the tamper store within the kernel, digitally signing the tamper store with a private key associated with the kernel, encrypting the tamper store, and the like.

Processing continues at block 414, where the OS binary image is created from the binaries, including the kernel, and tamper store. Creating the OS binary image may include, but is not limited to, creating an archive file, such as a Tape ARchive (TAR) file, ARC., PAK., ARJ., GZ., Cabinet (CAB.) file, compressed file, and the like. Virtually any mechanism may be employed to bundle the OS binaries into an image for delivery to a computer system. Upon completion of block 414, process 400 returns to perform other actions.

FIG. 5 illustrates a flow chart for one embodiment of a process for detecting tampering of a protected OS binary of FIG. 4, in accordance with the present invention. Process 500 may, for example, operate within tamper detector 206 of FIG. 2.

Process 500 begins, after a start block, at decision block 502, where a determination is made whether an action is requested by a protected binary. The action may include a read action, an execute operation, and the like. The action may also be performed during an initial install of the protected binary onto a computer system, wherein the action may be made on behalf of the protected binary by another program. In any event, if it is determined that the action is not requested by (or for) a protected binary, processing returns to perform other actions; otherwise, processing branches to block 504.

At block 504, a request to examine the requesting protected binary is received. In one embodiment, the kernel makes the request to an OS tamper detector. Integrity data associated with the requesting protected binary is retrieved. In one embodiment the integrity data is retrieved from the tamper store, as described above in conjunction with FIG. 4.

Processing continues at decision block 506 where the requesting protected binary is examined against the retrieved integrity data to determine if there may have been tampering. In one embodiment, examination includes generation of the integrity data from the requesting protected binary and a comparison of the generated integrity data against the retrieved integrity data. If the generated integrity data is substantially different from the retrieved integrity data, tampering may be assumed. If it is determined that tampering may have occurred, processing branching to block 508; otherwise, processing returns to perform other actions.

At block 508, an appropriate tamper detection action is performed. Such tamper detection action, may include, but is not limited to providing a tamper detection message, quarantining the suspected protected binary, and the like. Upon completion of block 508, processing returns to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended. The above specification, examples, and data provide a complete description of the manufacture and use of the composition of the invention. Since many embodiments of the invention can be made without departing from the spirit and scope of the invention, the invention resides in the claims hereinafter appended.

1. A method for protecting an operating system, comprising:
determining integrity data associated with an operating system binary, wherein the integrity data enables detection of a modification to the operating system binary; and
modifying a kernel with the integrity data, wherein the kernel is operable to employ the integrity data to detect the modification to the operating system binary.

2. The method of claim 1, wherein the integrity data further comprises at least one of a digital signature, and a hash associated with the operating system binary.

3. The method of claim 2, wherein the hash further comprises at least one a message digest, and a Secure Hash Algorithm (SHA).

4. The method of claim 1, wherein the modifying the kernel further comprises:
storing the integrity data in a data store; and
embedding the data store into the kernel.

5. The method of claim 4, wherein embedding the data store in the kernel further comprises at least one of digitally signing the data store, and encrypting the data store.

6. The method of claim 1, further-comprising generating an operating system image based in part on the modified kernel and the operating system user level binary, wherein the operating system image comprises at least one of creating an archive file, a compressed file, and a Cabinet (CAB) file.

7. The method of claim 1, wherein the operating system binary further comprises at least one of an OS user level binary, and the kernel.

8. A method for protecting an operating system, comprising;
generating a first integrity data associated with an operating system binary;
modifying an operating system kernel with the first integrity data;
receiving a request associated with the operating system binary;
retrieving the first integrity data associated with the operating system binary;
determining if the first integrity data indicates tampering of the operating system binary; and
performing a tamper detection action if the first integrity data indicates tampering of the operating system binary.

9. The method of claim 8, wherein receiving the request further comprises receiving at least one of a read action, an execute operation, and an install request.

10. The method of claim 8, wherein performing the tamper detection action further comprises at least one of providing a tamper detection message, and quarantining the operating system binary.

11. The method of claim 8, wherein the first integrity data further comprises at least one of a digital signature, and a hash associated with the operating system binary.

12. The method of claim 1, wherein the hash further comprises at least one a message digest, and a Secure Hash Algorithm (SHA).

13. The method of claim 8, wherein modifying the operating system kernel with the first integrity data further comprises storing the first integrity data in at least one of a database, a file, and a program.

14. The method of claim 8, wherein modifying the operating system kernel further comprises associating the first integrity data with the operating system kernel.

15. The method of claim 14, where associating the first integrity data with the operating system kernel further comprises digitally signing the first integrity data with a digital key associated with the operating system kernel.

16. The method of claim 8, wherein determining if the first integrity data indicates tampering of the operating system binary further comprises:
determining a second integrity data associated with the operating system binary;
determining if the first integrity data is substantially different from the second integrity data; and
indicating tampering of the operating system binary if the first integrity data is substantially different from the second integrity data.

17. The method of claim 16, wherein determining if the first integrity data is substantially different from the second integrity data further comprises comparing the second integrity data to the first integrity data.

18. A method for protecting an operating system, comprising:
receiving a request associated with an operating system binary;
retrieving integrity data associated with the operating system binary; and
performing a tamper detection action if the integrity data indicates tampering of the operating system binary.

19. The method of claim 18, wherein receiving the request further comprises receiving at least one of a read action, an execute operation, and an install request.

20. The method of claim 18, wherein performing the tamper detection action further comprises at least one of providing a tamper detection message, and quarantining the operating system binary.

21. The method of claim 18, wherein determining if the integrity data indicates tampering of the operating system binary further comprises:
determining another integrity data associated with the operating system binary;
determining if the other integrity data is substantially different from the retrieved integrity data; and
indicating tampering of the operating system binary if the other integrity data is substantially different from the retrieved integrity data.

22. A computer-readable medium having computer-executable components for protecting an operating system, comprising:
a data store configured to receive and store a first integrity data, wherein the first integrity data is associated with an operating system binary; and
a tamper detection component, coupled to the data store, that is arranged to perform actions, including:
receiving a request to examine an operating system binary;
retrieving the first integrity data associated with the operating system binary;
determining if the first integrity data indicates tampering of the operating system binary; and
performing a tamper detection action if the first integrity data indicates tampering of the operating system binary.

23. The computer-readable medium of claim 22, wherein the computer-executable components are associated with an operating system kernel.

24. The computer-readable medium of claim 22, wherein performing the tamper detection action further comprises at least one of providing a tamper detection message, and quarantining the operating system binary.

25. The computer-readable medium of claim 22, wherein the first integrity data further comprises at least one of a digital signature, and a hash associated with the operating system binary.

26. The computer-readable medium of claim 22, wherein the operating system binary further comprises at least one of an OS user level binary, and a kernel.

27. The computer-readable medium of claim 22, wherein determining if the first integrity data indicates tampering of the operating system binary further comprises:
determining a second integrity data associated with the operating system binary;
determining if the first integrity data is substantially different from the second integrity data, and
indicating tampering of the operating system binary if the first integrity data is substantially different from the second integrity data.

28. The computer-readable medium of claim 22, wherein the second integrity data further comprises at least one of a digital signature, and a hash associated with the operating system binary.

29. An apparatus for protecting an operating system, comprising:
means for receiving a request to examine an operating system binary;
means for retrieving a first integrity data associated with the operating system binary;
means for determining a second integrity data associated with the operating system binary; and
means for determining if the first integrity data is substantially different from the second integrity data, and if the first integrity data is substantially different from the second integrity data, a means for performing a tamper detection action.
